(19) United States
(12) Patent Application Publication
(10) Pub. No.: US 2021/0237732 A1
(43) Pub. Date: Aug. 5, 2021

(54) CONTROLLER, CONTROL METHOD, AND CONTROL SYSTEM

(71) Applicant: Toyota Jidosha Kabushiki Kaisha, Toyota-shi Aichi-ken (JP)

(72) Inventor: Keita Hashimoto, Toyota-shi (JP)

(21) Appl. No.: 17/165,366

(22) Filed: Feb. 2, 2021

(30) Foreign Application Priority Data
Feb. 4, 2020 (JP) 2020-016813

(51) Int. Cl. B60W 30/182

(52) U.S. Cl. CPC B60W 30/182; H04W 4/44

(57) ABSTRACT

A controller included in an apparatus: (i) identifies a first situation included in a condition for imposing a regulation on operation of the apparatus; (ii) identifies a second situation included in a condition for lifting the regulation imposed on the operation; (iii) if the first situation is not a predetermined first situation where the operation is regulated, controls the apparatus in a first mode in which a predetermined operation of the apparatus is permitted; (iv) if the first situation is the predetermined first situation, controls the apparatus in a second mode in which the predetermined operation is restricted; (v) if the second situation is a situation, which is a situation where it is desirable that the apparatus be controlled in the first mode, rather than the second mode, controls the apparatus in the first mode even if the first situation is the predetermined first situation.

### CROSS REFERENCE TO RELATED APPLICATIONS

This nonprovisional application claims priority to Japanese Patent Application No. 2020-016813 filed on Feb. 4, 2020 with the Japan Patent Office, the entire content of which is hereby incorporated by reference.

### BACKGROUND

### Field

The present disclosure relates to a controller, a control method, and a control system, and, more particularly, to a controller, a control method, and a control system for an apparatus.

### Description of the Background Art

Conventionally, a hybrid vehicle is disclosed which performs heating control for stopping the exhaust of exhaust gas as the vehicle, traveling on the travel route, enters, if present, a particular region in which the exhaust of exhaust gas is regulated (e.g., see Japanese Patent Laying-Open No. 2019-085094).

### SUMMARY

In urban areas in countries around the world, it is expected in the future that the ZEV (Zero Emission Vehicle) zone regulation and NEV (New Energy Vehicle) zone regulation will regulate the operational aspects of a vehicle, such as an exhaust gas exhaustion mode and an autonomous driving control mode, while the vehicle is in the zone.

However, if such regulation continues even in the event of a disaster or emergency, the restriction with respect to the EV range, due to the continuation of the EV (Electric Vehicle) mode regulation in the emergency situation, may hold up vehicles in the zone. Consequently, bad situations are expected to occur, such as the movement of users of the vehicles being restricted or traffic congestion affecting people having to do with the zone.

Thus, in a situation where it is not desirable that the apparatus be controlled in the mode where the operation of the apparatus is restricted, adverse conditions may result if the apparatus is under such control.

The present disclosure is made to solve the problem mentioned above, and an object of the present disclosure is to provide a controller, a control method, and a control system capable of preventing an operation of an apparatus from being regulated in a situation where no regulation on the operation of the apparatus is desirable.

The controller according the present disclosure is a controller for the apparatus, the controller including: a first identifying unit which identifies a first situation included in a condition for imposing a regulation on operation of the apparatus; a second identifying unit which identifies a second situation included in a condition for lifting the regulation imposed on the operation of the apparatus; and a control unit which controls the apparatus in a first mode if the first situation identified by the first identifying unit is not a predetermined first situation, the first mode being a mode in which a predetermined operation of the apparatus is permitted, the predetermined first situation being a situation where the operation of the apparatus is regulated, and controls the apparatus in a second mode if the first situation is the predetermined first situation, the second mode being a mode in which the predetermined operation is restricted. If the second situation identified by the second identifying unit is a predetermined second situation, which is a situation where it is desirable that the apparatus be controlled in the first mode, rather than the second mode, the control unit controls the apparatus in the first mode even if the first situation is the predetermined first situation.

According to such a configuration, if the second situation is the predetermined second situation, the apparatus is controlled in the first mode even if the first situation is the predetermined first situation. As a result, the controller can be provided which can prevent the operation of the apparatus from being regulated in a situation where no regulation on the operation of the apparatus is desirable.

The predetermined second situation may be an abnormal situation different from a normal situation. The apparatus may be a vehicle having an engine, the first situation may be a current location of the vehicle, the predetermined first situation may be a situation where the current location is within a regulated zone, the first mode may be a mode in which use of the engine is permitted, the second mode may be a mode in which the use of the engine is restricted, and the abnormal situation may be a situation where a disaster is occurring.

According to other aspect of the present disclosure, the control method is a method of control of an apparatus, the method including: identifying a first situation included in a condition for imposing a regulation on operation of the apparatus; identifying a second situation included in a condition for lifting the regulation imposed on the operation of the apparatus; controlling the apparatus in a first mode if the first situation identified is not a predetermined first situation, the first mode being a mode in which a predetermined operation of the apparatus is permitted, the predetermined first situation being a situation where the operation of the apparatus is regulated, and controlling the apparatus in a second mode if the first situation identified is the predetermined first situation, the second mode being a mode in which the predetermined operation is restricted; and if the second situation identified is a predetermined second situation, which is a situation where it is desirable that the apparatus be controlled in the first mode, rather than the second mode, controlling the apparatus in the first mode even if the first situation is the predetermined first situation.

According to such a configuration, the control method can be provided which can prevent the operation of the apparatus from being regulated in a situation where no regulation on the operation of the apparatus is desirable.

According to still other aspect of the present disclosure, the control system is a control system which includes a plurality of apparatuses and a server. The plurality of apparatuses each include: a first identifying unit which identifies a first situation included in a condition for imposing a regulation on operation of the apparatus; a second identifying unit which identifies a second situation included in a condition for lifting the regulation imposed on the operation of the apparatus, by obtaining the second situation from the server; and a control unit which controls the apparatus in a first mode if the first situation identified by the first identifying unit is not a predetermined first situation, the first mode being a mode in which a predetermined operation of the apparatus is permitted, the predetermined first situation being a situation where the operation of the apparatus is regulated, and controls the apparatus in a second mode if the first situation is the predetermined first situation, the second mode being a mode in which the predetermined operation is restricted. The server includes: a collecting unit which collects the second situation, and a communication unit which transmits the second situation collected by the collecting unit to the plurality of apparatuses. If the second situation identified by the second identifying unit is a predetermined second situation, which is a situation where it is desirable that the apparatus be controlled in the first mode, rather than the second mode, the control unit controls the apparatus in the first mode even if the first situation is the predetermined first situation.

According to such a configuration, the control system can be provided which can prevent the operation of the apparatus from being regulated in a situation where no regulation on the operation of the apparatus is desirable.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram showing a schematic configuration of a regulation system according to an embodiment.

FIG. 2 is a flowchart showing a flow of a process performed by the regulation system according to the embodiment.

FIG. 3 is a diagram for illustrating a restricted zone according to the embodiment.

FIG. 4 is a diagram for illustrating lifting of the restriction on use of an engine by an unrestricted mode, according to the embodiment.

FIG. 5 is a diagram for illustrating lifting of the restriction on use of an engine, according to Embodiment 2.

FIG. 6 is a flowchart showing a flow of a process performed by a regulation system according to Embodiment 3.

### DETAILED DESCRIPTION

Hereinafter, an embodiment according to the present disclosure will be described, with reference to the accompanying drawings. Note that the same reference signs are used to refer to the same or like parts, and the description thereof will not be repeated.

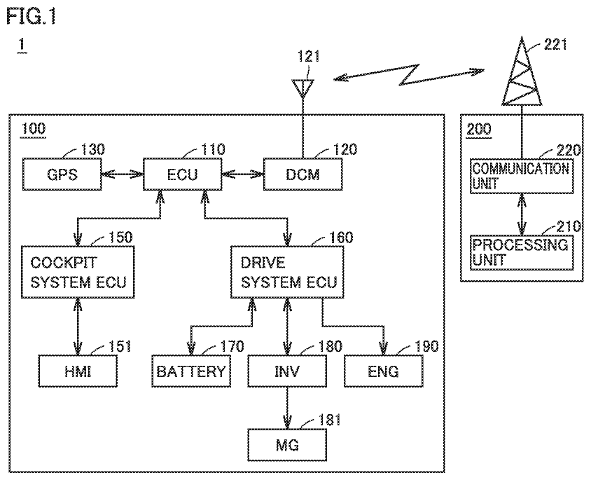

FIG. 1 is a diagram showing a schematic configuration of a regulation system 1 according to the present embodiment. Referring to FIG. 1, the regulation system 1 includes a vehicle 100 and a server 200. Assume that the vehicle 100 is a hybrid vehicle.

The vehicle 100 includes an electronic control unit (ECU) 110, a data communication module (DCM) 120, an antenna 121, a global positioning system (GPS) 130, a cockpit system ECU 150, a human machine interface (HMI) 151, a drive system ECU 160, a battery 170, an inverter 180, a motor generator (MG) 181, and an engine 190.

The ECU 110 includes a central processing unit (CPU), a memory, and input/output ports. The CPU processes data stored in the memory in accordance with programs stored in the memory, or processes data input from respective parts of the vehicle 100, and outputs a result of the processing to the respective parts of the vehicle 100 or the memory.

The DCM 120 is a communication module capable of wireless communications with an external apparatus, such as a server 200, via the antenna 121, while exchanging information with the ECU 110.

The GPS 130 is controlled by the ECU 110, and identifies the current location of the vehicle 100, based on a radio wave from an artificial satellite. The ECU 110 controls the GPS 130 to identify the current location of the vehicle 100.

The cockpit system ECU 150 has a similar configuration to the ECU 110. The cockpit system ECU 150 controls a group of devices around the driver's seat, such as the HMI 151, while exchanging information with the ECU 110. The HMI 151 is a group of devices that, for example, outputs information to the driver or receives information from the driver, for example, a center display which includes an instrument panel, a head up display, and a touch panel.

The battery 170 stores, for example, externally supplied electric power, electric power that is generated by the engine 190, or electric power regenerated by the MG 181, and supplies the electric power to respective parts of the vehicle 100.

The drive system ECU 160 has a similar configuration to the ECU 110. The drive system ECU 160 controls the battery 170, the inverter 180, and the engine 190, while exchanging information with the ECU 110. Based on control signals from the drive system ECU 160, the engine 190 generates a driving force for the vehicle 100 by burning fuels.

For example, based on the control signals from the drive system ECU 160, the inverter 180 uses and supplies from the battery 170 the electric power for controlling the MG 181, or charges to the battery 170 the regenerated electric power supplied from the MG 181. The MG 181 rotates with the electric power from the inverter 180 to generate the driving force for the vehicle 100 or regenerate electric power through the regenerative braking of the vehicle 100, and supply the electric power to the inverter 180.

The server 200 is a computer, and includes a processing unit 210 and a communication unit 220. The processing unit 210 includes a CPU, a memory, and a mass storage device. The CPU processes data stored in the memory or the mass storage device or data input from respective components of the server 200, in accordance with programs stored in the memory or the mass storage device, and outputs a result of the process to the respective components of the server 200, the memory, or the mass storage device.

The communication unit 220 performs wireless communications with an external apparatus, such as the vehicle 100, via the antenna 221, while exchanging information with the processing unit 210.

### Embodiment 1

In such a regulation system 1, it is contemplated that the vehicle 100 performs a control for stopping the exhaust of exhaust gas as the vehicle 100, traveling on the travel route, enters, if present, a particular region in which the exhaust of exhaust gas is regulated. Specifically, in urban areas in countries around the world, it is expected in the future that the ZEV zone regulation and NEV zone regulation will regulate the operational aspects of a vehicle, such as an exhaust gas exhaustion mode and an autonomous driving control mode, while the vehicle is in the zone.

However, if such regulation continues even in the event of a disaster or emergency, the restriction with respect to the EV range, due to the continuation of the EV mode regulation in the emergency situation, may hold up the vehicle 100 in the zone. Consequently, bad situations are expected to occur, such as the movement of the user of the vehicle 100 being restricted or traffic congestion affecting people having to do with the zone.

Thus, in a situation where it is not desirable that an apparatus, such as the vehicle 100, be controlled in the mode where the operation of the apparatus is restricted, adverse conditions may result if the apparatus is under such control.

Therefore, a controller, included in the apparatus such as the vehicle 100, which is configured of the ECU 110, the DCM 120, the GPS 130, the cockpit system ECU 150, and the drive system ECU 160, etc. of the vehicle 100, identifies a first situation that is information included in a condition for imposing regulation on the operation of the apparatus, and identifies a second situation that is information included in a condition for lifting the regulation on the operation of the apparatus. If the identified first situation is not a predetermined first situation where the operation of the apparatus is regulated, the controller controls the apparatus in a first mode in which a predetermined operation of the apparatus is permitted. In contrast, if the identified first situation is the predetermined first situation, the controller controls the apparatus in a second mode in which the predetermined operation is restricted. If the identified second situation is a predetermined second situation where it is desirable that the apparatus be controlled in the first mode, rather than the second mode, the controller controls the apparatus in the first mode even if the first situation is the predetermined first situation.

Thus, if the second situation is the predetermined second situation, the apparatus is controlled in the first mode even if the first situation is the predetermined first situation. As a result, the operation of the apparatus can be prevented from being regulated in a situation where no regulation on the operation of the apparatus is desirable.

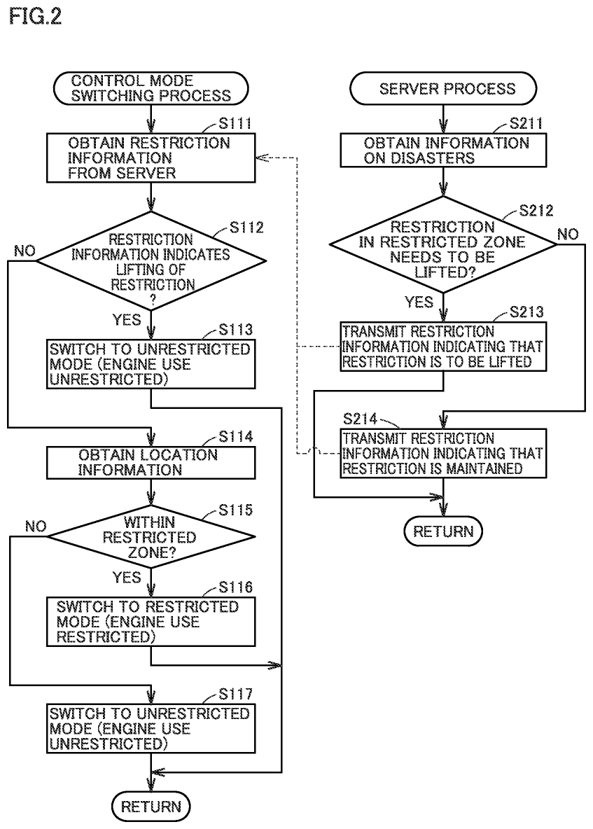

FIG. 2 is a flowchart showing a flow of a process performed by the regulation system 1 according to the present embodiment. Referring to FIG. 2, a server process is called from an upper process by the CPU of the processing unit 210 included in the server 200, and performed. A control mode switching process is called at predetermined intervals from an upper process by the CPU of the ECU 110 included in the vehicle 100, and performed.

The processing unit 210 included in the server 200 obtains information on disasters (step S211). The processing unit 210 may obtain the information on disasters from an external server, such as a news server, or collect such information from multiple vehicles 100 via the DCM 120.

Using the obtained information on disasters, the processing unit 210 determines whether restriction on the operation of an apparatus, such as the engine 190 that exhausts exhaust gas, in a restricted zone needs to be lifted (step S212).

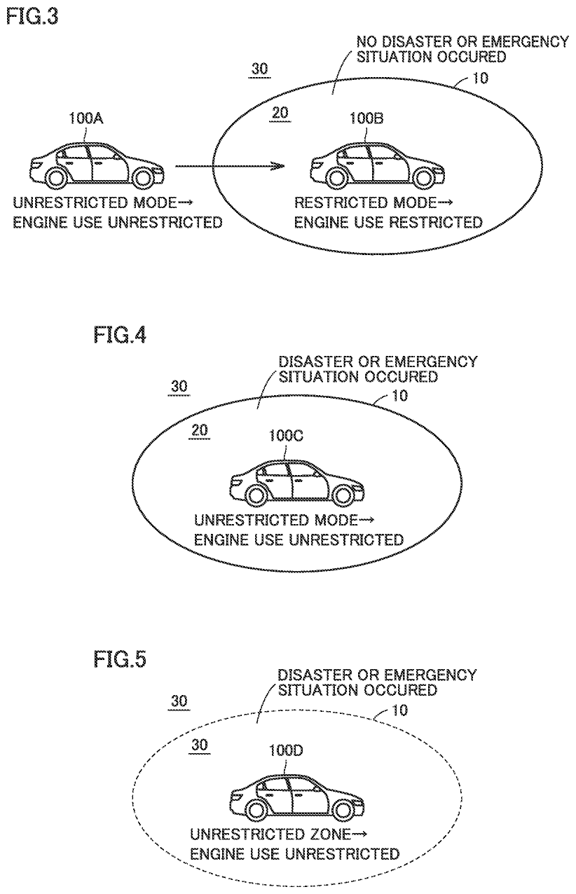

FIG. 3 is a diagram for illustrating a restricted zone according to the present embodiment. Referring to FIG. 3, a restricted zone 20 is a geographic region defined by a geofence 10 which is a perimeter. The restricted zone 20 is separated from an unrestricted zone 30 by the geofence 10.

In the present embodiment, in the restricted zone 20 defined by the geofence 10, a restriction is imposed on the operation of an apparatus of the vehicle 100, such as the engine 190 that exhausts exhaust gas. For example, no restriction is imposed on the exhaust of exhaust gas by the vehicle 100A that is in the unrestricted zone 30 outside the geofence 10. In contrast, restriction is imposed on the exhaust of exhaust gas by the vehicle 100B that is in the restricted zone 20 within the geofence 10. As the vehicle 100A, whose exhaust of exhaust gas is not restricted, leaves the unrestricted zone 30 and enters the restricted zone 20, the restriction is imposed on the exhaust of exhaust gas by the vehicle 100A, as with the vehicle 100B.

Returning to FIG. 2, for example, if the server 200 obtains information that a disaster, such as a flood or an earthquake, has occurred in the restricted zone 20 or that a state of emergency, such as a riot or a battle has commenced in the restricted zone 20, the server 200, in step S212, determines whether the restriction on the operation of the apparatus that exhausts exhaust gas in the restricted zone 20 is to be lifted.

If determined that the restriction in the restricted zone 20 needs to be lifted (YES in step S212), the processing unit 210 controls the communication unit 220 so that the communication unit 220 transmits to the vehicle 100 restriction information indicating that the restriction is to be lifted (step S213).

In contrast, if determined that lifting of the restriction in the restricted zone 20 is not necessary (NO in step S212), the processing unit 210 controls the communication unit 220 so that the communication unit 220 transmits to the vehicle 100 restriction information indicating that the restriction is maintained (step S214). After steps S213 and S214, the processing unit 210 returns the process to the caller upper process. The ECU 110 included in the vehicle 100 obtains the restriction information from the server 200 (step S111). The ECU 110 then determines whether the obtained restriction information indicates lifting of the restriction (step S112).

If determined that the obtained restriction information indicates lifting of the restriction (YES in step S112), the ECU 110 switches the mode of the vehicle 100 to an unrestricted mode (step S113), and returns the process to the caller upper process. As such, if the vehicle 100 is in the unrestricted mode, the ECU 110 does not restrict the use of the engine 190.

In contrast, if determined that the obtained restriction information does not indicate lifting of the restriction (NO in step S112), the ECU 110 obtains the current location of the vehicle 100 from the GPS 130 (step S114), and determines whether the obtained location is within the restricted zone 20 (step S115).

If determined that the current location is within the restricted zone 20 (YES in step S115), the ECU 110 switches the mode of the vehicle 100 to a restricted mode (step S116), and returns the process to the caller upper process. As such, if the vehicle 100 is in the restricted mode, the ECU 110 restricts the use of the engine 190.

If the current location is out of the restricted zone 20 (NO in step S115), that is, the current location is within the unrestricted zone 30, the ECU 110 switches the mode of the vehicle 100 to the unrestricted mode mentioned above (step S117), and returns the process to the caller upper process.

FIG. 4 is a diagram for illustrating lifting of the restriction on use of the engine 190 by the unrestricted mode, according the present embodiment. Referring to FIG. 4, if the vehicle 100C is set to the unrestricted mode, the use of the engine 190 will not be restricted, even if the vehicle 100C is in the restricted zone 20 within the geofence 10.

### Embodiment 2

According to Embodiment 1, as shown in FIG. 4, the vehicle 100 is switched to the unrestricted mode in the event of a disaster or emergency so that the use of the engine 190 is not restricted while the vehicle 100 is in the restricted zone 20 within the geofence 10.

FIG. 5 is a diagram for illustrating lifting of the restriction on use of the engine 190, according to Embodiment 2. Referring to FIG. 5, in Embodiment 2, in the event of a disaster or emergency, if the vehicle 100 is in the restricted zone 20 before the geofence 10 is disabled, the use of the engine 190 will not be restricted because the location set as the restricted zone 20 turns to the unrestricted zone 30 by disabling the geofence 10.

### Embodiment 3

According to Embodiment 1, as shown in FIG. 2, the restriction information is obtained at predetermined intervals. In Embodiment 3, restriction information is obtained only if the vehicle 100 is in the restricted zone 20.

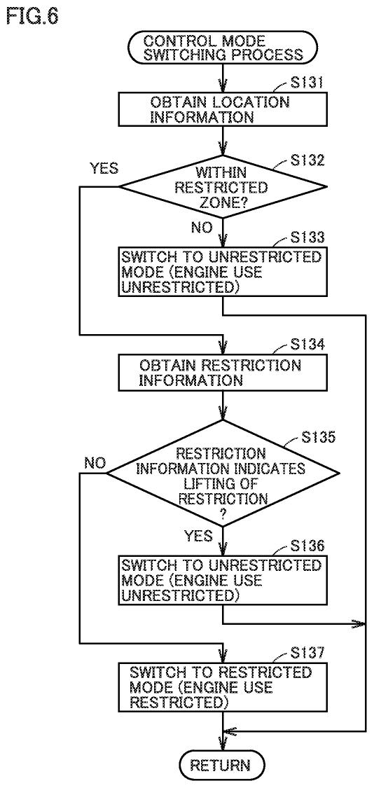

FIG. 6 is a flowchart showing a flow of a process performed by a regulation system 1 according to Embodiment 3. Referring to FIG. 6, a control mode switching process is called at predetermined intervals from an upper process by the CPU of an ECU 110 included in a vehicle 100.

The ECU 110 included in the vehicle 100 obtains the current location of the vehicle 100 from the GPS 130 (step S131), and determines whether the obtained location is within a restricted zone 20 indicated on a map pre-stored in a memory of the ECU 110 (step S132).

If determined that the current location is out of the restricted zone 20 (NO in step S132), that is, the current location is within a unrestricted zone 30, the ECU 110 switches the mode of the vehicle 100 to a unrestricted mode (step S133), and returns the process to the caller upper process. As such, if the vehicle 100 is in the unrestricted mode, the ECU 110 does not restrict the use of the engine 190.

If determined that the current location is within the restricted zone 20 (YES in step S132), the ECU 110 obtains restriction information related to the restricted zone 20 where the vehicle 100 is currently located (step S134). The restriction information is used to determine whether the restriction in the restricted zone 20 encompassing the current location of the vehicle 100 is to be lifted. The restriction information is information indicating whether a disaster or a state of emergency is occurring in the restricted zone 20 encompassing the current location of the vehicle 100. As with FIG. 2, the ECU 110 may obtain the restriction information from the server 200, or the ECU 110 included in the vehicle 100 may individually obtain the restriction information from various information sources.

The ECU 110 determines whether the restriction information indicates lifting of the restriction in the restricted zone 20 encompassing the current location of the vehicle 100 (step S135). If determined that the restriction information indicates lifting of the restriction (YES in step S135), the ECU 110 switches the mode of the vehicle 100 to the unrestricted mode (step S136), and returns the process to the caller upper process.

In contrast, if determined that the restriction information does not indicate lifting of the restriction (NO in step S135), the ECU 110 switches the mode of the vehicle 100 to the restricted mode (step S137), and returns the process to the caller upper process. As such, if the vehicle 100 is in the restricted mode, the ECU 110 restricts the use of the engine 190.

[Variation]

(1) In the embodiments described above, the restriction on the operation of the apparatus, such as the vehicle 100, may refer to not allowing the operation of the apparatus, partial restriction on the operation of the apparatus, or suppression of the operation of the apparatus. For example, the restriction on the operation of the engine 190 of the vehicle 100 may refer to not allowing the operation of the engine 190, not allowing the operation of the engine during a particular time period (e.g., rush hour), or suppression of the operation of the engine 190 due to restriction on the rotational speed of the engine 190 (e.g., restricted to 3000 rpm or less).

(2) In the embodiments described above, the apparatus whose operation is restricted is the vehicle 100. However, the present disclosure is not limited thereto. The apparatus whose operation is restricted may be a mobile terminal, such as a smartphone, or an electric power generating device (including a hybrid vehicle) which is movable and exhausts exhaust gas.

For example, if the apparatus whose operation is restricted is a mobile terminal, the communication capacity or communication speed of the mobile terminal in the geofence 10 is restricted. If the apparatus whose operation is restricted is an electric power generating device, the exhaust of exhaust gas from the electric power generating device in the geofence 10 is restricted.

(3) In the embodiments described above, the operation of the engine 190 of the vehicle 100 is a target to be restricted. However, the present disclosure is not limited thereto. Automated driving or driver-assistance of the vehicle 100 may be restricted, or a parked or stopped vehicle under the automated driving control may be restricted. Moreover, one of a CD (Charge Depleting) mode and a CS (Charge Sustaining) mode of a hybrid vehicle may be restricted, where SOC (State Of Charge) of the battery is consumed in the CD mode and SOC of the battery is maintained within a predetermined range in the CS mode.

A target to be restricted may be a dedicated lane that is restricted by vehicle restriction hour. In this case, the vehicle is, normally, restricted from traveling on the dedicated lane during the vehicle restriction hour, whereas the restriction on the vehicle from traveling on the dedicated lane during the vehicle restriction hour is lifted in the event of an abnormal situation.

(4) In the embodiments described above, as described with respect to FIG. 2, if the restriction information obtained from the server 200 indicates that the restriction is to be lifted, the restriction is to be lifted even though the location of the vehicle 100 is within the restricted zone 20. However, the present disclosure is not limited thereto. If the restriction information is not available from the server 200, the server 200 may not be in operation due to a disaster or an abnormal situation. Thus, the restriction may be lifted, regardless of the restriction information, when the vehicle 100 is located within the restricted zone 20.

(5) In the embodiments described above, the operation of the apparatus is normally restricted if the apparatus is within the restricted zone 20, whereas the operation of the apparatus within the restricted zone 20 is not restricted at the time of an abnormal situation. However, the present disclosure is not limited thereto. At the time of an abnormal situation, the operation of the apparatus may be restricted if the apparatus is within the restricted zone 20, and the operation of the apparatus within the restricted zone 20 normally may not be restricted.

For example, at the time of an abnormal situation, such as in the event of a disaster or emergency occurred in the restricted zone 20, if the apparatus is a smart meter and the smart meter is within the restricted zone 20, the energy (such as electric power, city gas, etc.) supplied via the smart meter may be restricted so as to be supplied, depending on a priority of the destination (e.g., hospitals and facilities designated as a shelter are given a higher priority, and general houses and general businesses, etc. are given a lower priority). After the abnormal situation is cleared, the supply of energy may not be restricted for the smart meter within the restricted zone 20.

At the time of an abnormal situation, such as in the event of a disaster or emergency occurred in the restricted zone 20, if the apparatus is a mobile terminal and the mobile terminal is within the restricted zone 20, the communications may be restricted so are to be given a priority, depending on a priority of the user of the mobile terminal (e.g., highly-public fire and police departments, etc. are given a higher priority, and ordinary citizens are given a lower priority). After the abnormal situation is cleared, normally, the communication may not be restricted for the mobile terminal within the restricted zone 20.

### CONCLUSION

(1) As shown in FIGS. 1 through 6, the controller of the apparatus such as the vehicle 100, which includes the ECU 110, the DCM 120, the GPS 130, the cockpit system ECU 150, and the drive system ECU 160, etc. of the vehicle 100, identifies a first situation (e.g., location, date and time) included in a condition for imposing a regulation on operation of the apparatus (step S114, step S131), and identifies a second situation (e.g., restriction information) included in a condition for lifting the regulation imposed on the operation of the apparatus (step S111, step S134).

If the identified first situation is not a predetermined first situation (e.g., within the restricted zone 20) where the operation of the apparatus is regulated, the apparatus is controlled in a first mode (e.g., the unrestricted mode) in which a predetermined operation of the apparatus (e.g., use of the engine 190) is permitted (step S117, step S133). If the identified first situation is the predetermined first situation, the apparatus is controlled in a second mode (e.g., the restricted mode) in which the predetermined operation is restricted (step S116, step S137).

If the identified second situation is a predetermined second situation where it is desirable that the apparatus be controlled in the first mode, rather than the second mode, (e.g., a situation where the restriction is lifted), the apparatus is controlled in the first mode, even if the first situation is the predetermined first situation (step S113, step S138).

With this, if the second situation is the predetermined second situation, the apparatus is controlled in the first mode even if the first situation is the predetermined first situation. As a result, the operation of the apparatus can be prevented from being regulated in a situation where no regulation on the operation of the apparatus is desirable.

(2) As shown in FIGS. 2 through 6, the predetermined second situation is an abnormal situation (e.g., a disaster or emergency is occurring) different from a normal situation (e.g., a normal situation different from the time of a disaster or emergency).

(3) As shown in FIGS. 1 through 6, the apparatus is the vehicle 100 having the engine 190; the first situation is the current location of the vehicle 100; the predetermined first situation is a situation where the current location of the vehicle 100 is within the restricted zone 20; the first mode is a mode in which the use of the engine 190 is permitted; the second mode is a mode in which the use of the engine 190 is restricted; and the abnormal situation is a situation where a disaster is occurring.

(4) As shown in FIGS. 1 through 6, the control method is a method of control of an apparatus such as the vehicle 100, the method including: identifying a first situation (e.g., location, date and time) included in a condition for imposing a regulation on operation of the apparatus (step S114, step S131); identifying a second situation (e.g., the restriction information) included in a condition for lifting the regulation imposed on the operation of the apparatus (step S111, step S134); controlling the apparatus in a first mode (e.g., the unrestricted mode) if the identified first situation is not a predetermined first situation (e.g., within the restricted zone 20) (step S117, step S133), the first mode being a mode in which a predetermined operation of the apparatus (e.g., use of the engine 190) is permitted, the predetermined first situation being a situation where the operation of the apparatus is regulated, and controlling the apparatus in a second mode (e.g., the restricted mode) if the identified first situation is the predetermined first situation, the second mode being a mode in which the predetermined operation is restricted (step S116, step S137); and if the identified second situation is a predetermined second situation (e.g., a situation where the restriction is lifted), which is a situation where it is desirable that the apparatus be controlled in the first mode, rather than the second mode, controlling the apparatus in the first mode even if the first situation is the predetermined first situation (step S113, step S138).

This can prevent the operation of the apparatus from being regulated in a situation where no regulation on the operation of the apparatus is desirable.

(5) The regulation system 1 is a system which includes a plurality of apparatuses, such as the vehicle 100, and the server 200. The plurality of apparatuses each: identify a first situation included in a condition for imposing a regulation on operation of the apparatus; identify a second situation included in a condition for lifting the regulation imposed on the operation of the apparatus, by obtaining the second situation from the server; control the apparatus in a first mode if the identified first situation is not a predetermined first situation, the first mode being a mode in which a predetermined operation of the apparatus is permitted, the predetermined first situation being a situation where the operation of the apparatus is regulated, and control the apparatus in a second mode if the identified first situation is the predetermined first situation, the second mode being a mode in which the predetermined operation is restricted. The server 200 collects the second situation (step S211), and transmits the collected second situation to the plurality of apparatuses (step S213, step S214). If the identified second situation is a predetermined second situation which is a situation where it is desirable that the apparatus be controlled in the first mode, rather than the second mode, the apparatus is controlled in the first mode even if the first situation is the predetermined first situation.

This can prevent the operation of the apparatus from being regulated in a situation where no regulation on the operation of the apparatus is desirable.

Although the present disclosure has been described and illustrated in detail, it is clearly understood that the same is by way of illustration and example only and is not to be taken by way of limitation, the scope of the present disclosure being interpreted by the terms of the appended claims.

What is claimed is:

1. A controller included in an apparatus, the controller comprising:
a first identifying unit which identifies a first situation included in a condition for imposing a regulation on operation of the apparatus;
a second identifying unit which identifies a second situation included in a condition for lifting the regulation imposed on the operation of the apparatus; and
a control unit which
controls the apparatus in a first mode if the first situation identified by the first identifying unit is not a predetermined first situation, the first mode being a mode in which a predetermined operation of the apparatus is permitted, the predetermined first situation being a situation where the operation of the apparatus is regulated, and
controls the apparatus in a second mode if the first situation is the predetermined first situation, the second mode being a mode in which the predetermined operation is restricted, wherein
if the second situation identified by the second identifying unit is a predetermined second situation, which is a situation where it is desirable that the apparatus be controlled in the first mode, rather than the second mode, the control unit controls the apparatus in the first mode even if the first situation is the predetermined first situation.

2. The controller according to claim 1, wherein
the predetermined second situation is an abnormal situation different from a normal situation.

3. The controller according to claim 2, wherein
the apparatus is a vehicle having an engine,
the first situation is a current location of the vehicle,
the predetermined first situation is a situation where the current location is within a regulated zone,
the first mode is a mode in which use of the engine is permitted,
the second mode is a mode in which the use of the engine is restricted, and
the abnormal situation is a situation where a disaster is occurring.

4. A method of control of an apparatus, the method comprising:
identifying a first situation included in a condition for imposing a regulation on operation of the apparatus;
identifying a second situation included in a condition for lifting the regulation imposed on the operation of the apparatus;
controlling the apparatus in a first mode if the first situation identified is not a predetermined first situation, the first mode being a mode in which a predetermined operation of the apparatus is permitted, the predetermined first situation being a situation where the operation of the apparatus is regulated, and controlling the apparatus in a second mode if the first situation identified is the predetermined first situation, the second mode being a mode in which the predetermined operation is restricted; and
if the second situation identified is a predetermined second situation, which is a situation where it is desirable that the apparatus be controlled in the first mode, rather than the second mode, controlling the apparatus in the first mode even if the first situation is the predetermined first situation.

5. A control system, comprising a plurality of apparatuses and a server,
the plurality of apparatuses, each apparatus including:
a first identifying unit which identifies a first situation included in a condition for imposing a regulation on operation of the apparatus;
a second identifying unit which identifies a second situation included in a condition for lifting the regulation imposed on the operation of the apparatus, by obtaining the second situation from the server; and
a control unit which
controls the apparatus in a first mode if the first situation identified by the first identifying unit is not a predetermined first situation, the first mode being a mode in which a predetermined operation of the apparatus is permitted, the predetermined first situation being a situation where the operation of the apparatus is regulated, and
controls the apparatus in a second mode if the first situation is the predetermined first situation, the second mode being a mode in which the predetermined operation is restricted,
the server including:
a collecting unit which collects the second situation, and
a communication unit which transmits the second situation collected by the collecting unit to the plurality of apparatuses, wherein
if the second situation identified by the second identifying unit is a predetermined second situation, which is a situation where it is desirable that the apparatus be controlled in the first mode, rather than the second mode, the control unit controls the apparatus in the first mode even if the first situation is the predetermined first situation.
